(19) United States
(12) Patent Application Publication
(10) Pub. No.: US 2007/0155645 A1
(43) Pub. Date: Jul. 5, 2007

(54) Wipes

(76) Inventors: Wolf Eisfeld, Duesseldorf (DE); Esther Kuesters, Duesseldorf (DE); Susanne Dickhof, Viersen (DE); Sandra Marten, Duesseldorf (DE); Ansgar Behler, Bottrop (DE); Ulrich Issberner, Ambler, PA (US)

Correspondence Address: COGNIS CORPORATION;PATENT DEPARTMENT, 300 BROOKSIDE AVENUE, AMBLER, PA, 19002, US

(21) Appl. No.: 11/639,732

(22) Filed: Dec. 14, 2006

(30) Foreign Application Priority Data
Dec. 16, 2005 (DE) 10 2005 060 733.0

(51) Int. Cl. C11D 17/00

(52) U.S. Cl. 510/439

(57) ABSTRACT

The invention relates to cleaning wipes which are characterized in that a water-insoluble substrate is impregnated with an alkylether citrate partial ester.

### CROSS-REFERENCE TO RELATED APPLICATIONS

This application claims priority from German application number DE 102005060733.0 filed Dec. 16, 2005, the entire contents of which are incorporated herein by reference.

### FIELD OF THE INVENTION

This invention relates to dry and wet wipes and to their use in the cleaning and care of skin and hair.

### BACKGROUND OF THE INVENTION

Wet and dry wipes are enjoying ever-increasing popularity and importance in the cosmetics field. Besides well-known kitchen towels, toilet papers, paper handkerchiefs, face cloths and pads, refreshing towels and the like, there are also wet wipes Wet wipes are sheet-form textiles of various types (nonwovens, tissues or papers) which are impregnated with a solution. Dry or wet wipes for cleaning the skin and hair, which are impregnated with solutions containing surfactants and conditioners, are known from U.S. Pat. No. 5,972,361, U.S. Pat. No. 6,063,397, U.S. Pat. No. 5,980,931 and WO 98/18446.

Another form of hair cleaning consists in the use of water-free cleaning powders which bind fats and soil constituents present in the hair and which are subsequently removed from the hair with a towel or by brushing. This way of cleaning the hair is very popular when time is short or not enough water is available, as for example on journeys. However, this often has the effect that the hair not only looks dull and grayish, it also has an unpleasant feel, particularly in the case of long hair.

Accordingly, the problem addressed by the present invention was to provide wipes which would have a positive effect on the sensory properties of skin and hair. Thus, the hair would show increased volume and no discoloration after cleaning with the wipes according to the invention, but nevertheless the wipes according to the invention would have a good cleaning effect and would be quick and easy to use.

### BRIEF DESCRIPTION OF THE INVENTION

The present invention relates to wipes which are characterized in that a water-insoluble substrate is impregnated with an alkyl ether citrate. It has surprisingly been found that such wipes have excellent cleaning properties and, at the same time, a conditioning effect on the skin and hair. The wipes according to the invention do not leave any discoloring deposits on the skin or hair and improve hair volume and luster. The wipes according to the invention may be used dry or may be moistened in water before use.

### DETAILED DESCRIPTION OF THE INVENTION

Alkylether Citrates

By using alkylether citrates on sheet-form materials, the skin and hair are not only cleaned, but also conditioned. The skin and hair then show greater softness and the hair is distinguished by greater volume. This leads to an improved tactile feel and to an improved care effect. Skin and hair cleaned with the wipes according to the invention are left with fewer residues of the cleaning preparation and are thus less burdened with “foreign” substances.

The alkylether citrates according to the invention are derived from ethoxylated alcohols corresponding to the following general formula:
R¹O(CH₂CH₂O)ₙH (I)
in which R¹ is an alkyl group and n stands for the degree of ethoxylation. R¹ is preferably a linear alkyl group of a fatty alcohol mixture containing 45 to 75% by weight C₁₂, 15 to 35% by weight C₁₄, 0 to 15% by weight C₁₆ and 0 to 20% by weight C₁₈ alcohol and n is a number of 5 to 9, with the proviso that the ratio by weight of monoester to diester in the alkyl ether citrates is in the range from 3:1 to 10:1.

The alcohol mixtures are mixtures primarily of capric alcohol, lauryl alcohol, myristyl alcohol, cetyl alcohol and/or stearyl alcohol in the ratios by weight indicated. The mixtures are obtainable either by mixing the individual alcohols or by mixing corresponding alcohol mixtures. In one embodiment of the present invention, alkylether citrates of alcohols corresponding to formula (I), in which R¹ is a linear alkyl group derived from a fatty alcohol mixture containing 65 to 75% by weight C₁₂, 20 to 30% by weight C₁₄, 0 to 5% by weight C₁₆ and 0 to 5% by weight C₁₈ alcohol, are preferred. These alcohol mixtures on which the alkylether citrates are based are commercially available alcohol mixtures, for example Dehydol LS™, a product of Cognis Deutschland GmbH & Co. KG. The fatty alcohol mixture has the following chain distribution in % by weight: C₁₀: 0 to 2; C₁₂: 70 to 75; C₁₄: 24 to 30: C₁₆: 0 to 2, and is obtainable, for example, from palm kernel oil or coconut oil.

In another embodiment of the present invention, alkylether citrates of ethoxylated alcohols corresponding to formula (I), in which R¹ is a linear alkyl group derived from a fatty alcohol mixture containing 45 to 60% by weight C₁₂, 15 to 30% by weight C₁₄, 5 to 15% by weight C₁₆ and 8 to 20% by weight C₁₈ alcohol, are preferred. These alcohol mixtures on which the alkylether citrates are based are commercially available alcohol mixtures, for example Dehydol LT™, a product of Cognis Deutschland GmbH & Co. KG. The fatty alcohol mixture has the following chain distribution in % by weight: <C₁₂: 0 to 3; C₁₂: 48 to 58; C₁₄: 18 to 24: C₁₆: 8 to 12; C₁₈: 11 to 15; >C18: 0 to 1%, and is obtainable, for example, from palm kernel oil or coconut oil.

According to the invention, the degree of ethoxylation n is preferably a number of 6 to 8 which may be a whole or broken number.

Ethoxylation products of fatty alcohol mixtures containing 45 to 60% by weight C₁₂, 15 to 30% by weight C₁₄, 5 to 15% by weight C₁₆ and 8 to 20% by weight C₁₈ alcohol with 6 to 8 mol ethylene oxide and, more particularly, the ethoxylation product of Dehydol LT™ with 7 mol ethylene oxide are particularly advantageous.

The (fatty) alcohol mixtures may contain small quantities of short-chain or relatively long-chain alcohols, preferably less than 10% by weight and more particularly less than 5% by weight in all, based on the alcohol mixtures.

The alkylether citrates according to the invention are mixtures of isomeric compounds corresponding to the following general formula: 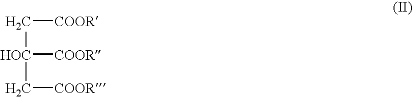
in which R′, R″ and R″ stand for X and/or an ethoxylated alkyl group R¹ with the meaning defined in formula (I), the distribution of the substituents R′, R″ and R′″ being subject to the proviso that the ratio by weight of monoester to diester is in the range from 3:1 to 10:1. The ratio by weight of monoester to diester is preferably in the range from 5:1 to 8:1.

Accordingly, the alkylether citrates according to the invention must contain mono- and diesters, preferably in quantities of 50 to 90% by weight and more particularly in quantities of 60 to 80% by weight, expressed as mono- and diester and based on the mixture. The mixtures may contain triesters and free citric acid as the balance to 100% by weight. However, the mixtures preferably contain little free citric acid, preferably less than 10% by weight, based on the mixtures.

Accordingly, the alkylether citrates according to the invention are mainly partial esters of citric acid which still contain at least one free carboxyl group. Accordingly, they may even be acidic esters or neutralization products thereof and X in formula (II) may represent hydrogen or a cation. The partial esters are then preferably present in the form of alkali metal, alkaline earth metal, ammonium, alkylammonium, alkanolammonium and/or glucammonium salts (i.e. X stands for alkali metal, alkaline earth metal, ammonium, alkylammonium, alkanolammonium and/or glucammonium ion).

The alkylether citrates to be used in accordance with the invention are distinguished in particular by their ability to limit the absorption of alkylether sulfates onto the skin and hair and, accordingly, are known as mild surfactants.

Water-Insoluble Substrates

Suitable water-insoluble substrates are single-layer or multi-layer sheet-form materials. Besides paper tissues, corresponding tissue cloths made from fibers or nonwovens may also be used. Examples of natural fibers include silk, cellulose, keratin, wool, cotton, jute, linen, flax; examples of synthetic fibers include acetate, acrylate, cellulose ester, polyamide, polyester, polyolefin, polyvinyl alcohol, polyurethane fibers or even additive-hydrophilicized woven polyolefin fabrics and blends of these fibers or woven fabrics. Reaction products of 1 part polyethylene glycol with 2 parts C₁₀₋₁₂ fatty acids or derivatives thereof are used for hydrophilicizing the polyolefin-containing fabrics.

Nonwoven materials are preferred because they can be better provided with the desired structure according to the invention, substrates of viscose/polyester blends being particularly suitable. However, hydroentangled substrate systems of 50 to 90% by weight viscose and 50 to 10% by weight polyester are preferred, substrates of 60 to 80% by weight viscose and 40 to 20% by weight polyester being particularly preferred. Substrates of 65 to 70% by weight viscose and 35 to 30% by weight polyester are most particularly preferred.

In terms of size, the wipes are generally between 100 and 500 mm in length and between 100 and 500 mm in width, lengths and widths of 120 to 220 mm being preferred. However, the fabric may even be in the form of a glove and, in that case, may possibly have a multi-ply structure so that the inner fabric layer of the glove is more hydrophobic, has a barrier function and protects the hand against contact with the formulation or with moisture.

By virtue of their production—for example by hydroentangling or meltbonding—the substrate fabrics of the cosmetic wipes according to the invention have a uniformly structured surface with round to oval depressions. These depressions—also known as pits—are round to oval in shape with a diameter or width of 0.1 to 1 mm and preferably 0.2 to 0.6 mm and a diameter or length of 0.5 to 5.0 mm and preferably 0.8 to 1.5 mm. They may be present on both sides or on only one side. Where they are present on one side, the depressions occupy between 50 and 99% and preferably between 60 and 85% of the thickness of the substrate. Where the depressions are present on both sides, this percentage has to be divided up accordingly. On average, between 500 and 4,000, preferably between 1,500 and 3,500 and more preferably between 2,500 and 3,200 pits are present per 100 mm² substrate surface area.

In another embodiment, the sheet-form materials are impregnated with at least one other surfactant besides the alkylether citrates. Known anionic, cationic, nonionic, zwitterionic and/or amphoteric surfactants may be used for this purpose.

Typical examples of anionic surfactants are soaps, alkyl benzene-sulfonates, alkanesulfonates, olefin sulfonates, alkylether sulfonates, glycerol ether sulfonates, α-methyl ester sulfonates, sulfofatty acids, alkyl sulfates, fatty alcohol ether sulfates, glycerol ether sulfates, fatty acid ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates, alkyl oligoglucoside carboxylates, protein fatty acid condensates (particularly wheat-based vegetable products) and alkyl (ether) phosphates. If the anionic surfactants contain polyglycol ether chains, they may have a conventional homolog distribution although they preferably have a narrow-range homolog distribution.

Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated tri-glycerides, mixed ethers and mixed formals, optionally partly oxidized alk(en)yl oligoglycosides or glucuronic acid derivatives, fatty acid-N-alkyl glucamides, protein hydrolyzates (particularly wheat-based vegetable products), polyol fatty acid esters, sugar esters, sorbitan esters, polysorbates and amine oxides. If the nonionic surfactants contain polyglycol ether chains, they may have a conventional homolog distribution, although they preferably have a narrow homolog distribution.

Typical examples of cationic surfactants are quaternary ammonium compounds, such as dimethyl distearyl ammonium chloride for example, and esterquats, more particularly quaternized fatty acid trialkanolamine ester salts. Typical examples of amphoteric or zwitterionic surfactants are alkylbetaines, alkylamidobetaines, aminopropionates, aminoglycinates, imidazolinium betaines and sulfobetaines. The surfactants mentioned are all known compounds.

Typical examples of particularly suitable mild, i.e. particularly dermatologically safe, surfactants are fatty alcohol polyglycol ether sulfates, monoglyceride sulfates, mono- and/or dialkyl sulfosuccinates, fatty acid isethionates, fatty acid sarcosinates, fatty acid taurides, fatty acid glutamates, α-olefin sulfonates, ether carboxylic acids, alkyl oligoglucosides, fatty acid glucamides, alkyl amidobetaines, amphoacetates and/or protein fatty acid condensates—the latter preferably based on wheat proteins.

In a particularly preferred embodiment, combinations of alkylether citrates with acylated amino acids—more particularly acyl glutamates—and/or alkyl oligoglucoside carboxylates are used.

According to the invention, the total quantity of surfactants should be between 0.1 and 10% by weight, based on the composition as a whole. Surfactant quantities above 10% by weight lead to absorption of the surfactants into the skin and hair, which is undesirable. Surfactant contents of 1 to 5% by weight, based on the composition as a whole, are particularly preferred.

Defatting Agents

The wipes according to the invention—particularly where they are intended for cleaning hair—may be additionally impregnated with a defatting agent. Particularly suitable defatting agents are lower, linear or branched alcohols, ethanol or isopropanol being particularly preferred.

Moisturizers

The wipes according to the invention may be additionally impregnated with a moisturizer. Particularly suitable moisturizers are polyhydric alcohols containing 1 to 3 carbon atoms, such as for example propylene glycol and glycerol, which are particularly preferred for the purposes of the invention.

Water and Other Auxiliaries

The wipes according to the invention may be impregnated with water-free or low-water cleaning preparations which are either directly impregnated onto the wipes with a low water content or which are applied in aqueous solution and then subjected to a drying step. Besides the ingredients already mentioned above, the compositions used to impregnate the wipes may contain other oil components, waxes, pearlizers and opacifiers, emulsifiers, thickeners, polymers, superfatting agents, stabilizers, silicone compounds, biogenic agents, deodorants and germ inhibitors, antiperspirants, film formers, anti-dandruff agents, swelling agents, insect repellents, self-tanning agents, depigmenting agents, hydrotropes, preservatives, UV protection factors, perfume oils, aromas and dyes.

The wipes according to the invention may be used as hair or skin cleaning wipes or as cleaning wipes for the cleaning and care of domestic pets and working animals.

### EXAMPLES

### Example 1

### Formulation for Impregnating Wipes (Quantities as Active Substance in % by Weight)

| | |
|---|---|
| Plantapon ® LC 7 | 1% |
| Plantapon ® S | 0.75% |
| Plantapon ® ACG 35 | 0.25% |
| Ethanol | 10% |
| Propylene Glycol | 3% |
| Water | to 100% |

### Example 2

### Formulation for Impregnating Wipes (Quantities as Active Substance in % by Weight)

| | |
|---|---|
| Plantapon ® LC 7 | 2% |
| Ethanol | 10% |
| Propylene Glycol | 3% |
| Water | 85% |

### Example 3

### Formulation for Impregnating Wipes (Quantities as Active Substance in % by Weight)

| | |
|---|---|
| Plantapon ® LC 7 | 13.34% |
| Ethanol | 66.66% |
| Propylene Glycol | 20% |

The above concentrate is mixed with water in a ratio of 3:17 (1 liter concentrate+5.67 liters water) before impregnation of the wipes.

### Example 4

### Formulation for Impregnating Wipes (Quantities as Active Substance in % by Weight)

| | |
|---|---|
| Plantapon ® LC 7 | 1% |
| Plantapon ® LGC | 1% |
| Ethanol | 10% |
| Propylene Glycol | 3% |
| Water | 85% |

### Example 5

The following Table shows formulations which can be sprayed by virtue of their sensitivity to shearing and/or their low viscosity and which are therefore particularly suitable for use for tissues, papers, wipes, sponges, plasters for baby hygiene, baby care, skin care, cleaning, facial cleaning. Quantities as % by weight.

TABLE 5

| Component | 1 | 2 | 3 | 4 | 5 | 6 |
|---|---|---|---|---|---|---|
| Glyceryl Stearate, Ceteareth-20, Ceteareth- | 3.7 | | | 4.1 | | |
| 12, Cetearyl Alcohol, Cetyl Palmitate | | | | | | |
| (Emulgade ® SE) | | | | | | |
| Cetearyl Glucoside, Cetearyl Alcohol | | | | | 5.0 | 1.0 |
| (Emulgade ® PL 68/50) | | | | | | |
| Polyglyceryl-2 Dipolyhydroxystearate, Lauryl | | | | | | |
| Glucoside, Glycerin (Eumulgin ® VL 75) | | | | | | |
| Sodium Stearoyl Glutamate (Eumulgin ® SG) | | | | | | 0.25 |
| Sucrose Polystearate, Hydrogenated | | | | | | |
| Polyisobutene (Emulgade ® Sucro) | | | | | | |
| Sodium Cetearyl Sulfate (Lanette ® E) | | | | | | |
| Ceteareth-12 (Eumulgin ® B1) | 1.3 | 1.8 | 1.0 | | | |
| Ceteareth-20 (Eumulgin ® B2) | | 7.6 | 8.0 | 0.9 | | |
| Potassium Cetyl Phosphate | | | | | 0.5 | |
| Cetearyl Alcohol (Lanette ® O) | | 1.8 | 4.5 | | | |
| Glyceryl Stearate (Cutina ® GMS V) | | 9.1 | 4.5 | | | |
| Pentaerythrityl Distearate (Cutina ® PES) | | | | | | |
| Cetearyl Isononanoate (Cetiol ® SN) | 3.0 | | 20 | | 3.5 | |
| Coco Caprylate/Caprate (Cetiol ® LC) | | | | 5.0 | | 1.0 |
| Dicaprylyl Carbonate (Cetiol ® CC) | 5.0 | | | 5.0 | 5.0 | |
| Ethyl Hexylstearate (Cetiol ® 868) | | 10 | | | | |
| Olus (Cegesoft ® PS6) | 1.5 | | | | 1.5 | |
| Caprylic/Capric Triglyceride (Myritol ® 312) | | | | | | 1.0 |
| Cocoglycerides (Myritol ® 331) | | | | | | |
| Dicaprylyl Ether (Cetiol ® OE) | | | | | | 1.0 |
| Dibutyl Adipate (Cetiol ® B) | | | | | | 5.5 |
| Glycerin | 2.0 | | 3.5 | 1.0 | | |
| Tocopheryl Acetate (Copherol ® 1250C) | 0.5 | | | 0.3 | | |
| Sodium Polyacrylate (Cosmedia ® SP) | | | | | | |
| Laureth-7 Citrate (Plantapon ® LC 7) | 2.0 | 0.5 | 1.5 | 1.0 | 1.0 | 0.5 |

| Water, Perfume, Preservative | q.s. | | | | | |
|---|---|---|---|---|---|---|
| Component | 7 | 8 | 9 | 10 | 11 | 12 |
| Glyceryl Stearate, Ceteareth-20, Ceteareth- | | | | | | |
| 12, Cetearyl Alcohol, Cetyl Palmitate | | | | | | |
| (Emulgade ® SE) | | | | | | |
| Cetearyl Glucoside, Cetearyl Alcohol | 3.0 | 1.0 | 1.0 | | 1.0 | |
| (Emulgade ® PL 68/50) | | | | | | |
| Polyglyceryl-2 Dipolyhydroxystearate, Lauryl | | | | 5.0 | | |
| Glucoside, Glycerin (Eumulgin ® VL 75) | | | | | | |
| Sodium Stearoyl Glutamate (Eumulgin ® SG) | 0.25 | | | | 0.25 | |
| Sucrose Polystearate, Hydrogenated | | | | | 0.7 | 2.0 |
| Polyisobutene (Emulgade ® Sucro) | | | | | | |
| Sodium Cetearyl Sulfate (Lanette ® E) | | 0.25 | 0.25 | | | |
| Ceteareth-12 (Eumulgin ® B1) | | | | | | |
| Ceteareth-20 (Eumulgin ® B2) | | | | | | |
| Potassium Cetyl Phosphate | | | | | | |
| Cetearyl Alcohol (Lanette ® O) | | | | | | |
| Glyceryl Stearate (Cutina ® GMS V) | | | | | | |
| Pentaerythrityl Distearate (Cutina ® PES) | | | | | 1.0 | 1.0 |
| Cetearyl Isononanoate (Cetiol ® SN) | | | | | | |
| Coco Caprylate/Caprate (Cetiol ® LC) | 1.0 | 1.0 | 1.0 | | 1.0 | |
| Dicaprylyl Carbonate (Cetiol ® CC) | | | | 4.0 | | 2.0 |
| Ethyl Hexylstearate (Cetiol ® 868) | | | | 2.0 | | 2.0 |
| Olus (Cegesoft ® PS6) | | | | | | |
| Caprylic/Capric Triglyceride (Myritol ® 312) | 1.0 | 1.0 | 1.0 | | 1.0 | 1.0 |
| Cocoglycerides (Myritol ® 331) | | | | 4.0 | | |
| Dicaprylyl Ether (Cetiol ® OE) | 1.0 | 1.0 | 1.0 | | 2.0 | 1.0 |
| Dibutyl Adipate (Cetiol ® B) | 5.0 | | | | | |
| Glycerin | 3.5 | 3.0 | 3.0 | 1.0 | 2.0 | |
| Tocopheryl Acetate (Copherol ® 1250C) | | | | | 0.5 | |
| Sodium Polyacrylate (Cosmedia ® SP) | | | 0.15 | | 0.2 | 0.5 |
| Laureth-7 Citrate (Plantapon ® LC 7) | 0.5 | 2.0 | 1.5 | 1.5 | 1.0 | 1.5 |

| | |
|---|---|
| Water, Perfume, Preservative | q.s. |

1. Cleaning wipes comprising: a water-insoluble substrate impregnated with an alkylether citrate partial ester mixture.

2. The cleaning wipes of claim 1, additionally impregnated with at least one additional surfactant.

3. The cleaning wipes of claim 1 additionally impregnated with a defatting agent.

4. The cleaning wipes of claim 1, additionally impregnated with a moisturizer.

5. The cleaning wipes of claim 3, wherein, the defatting agent comprises a member selected from the group consisting of ethanol, isopropanol and mixtures thereof.

6. The cleaning wipes of claim 4, wherein, the moisturizer comprises a member selected from the group consisting of polyhydric alcohols containing 1 to 3 carbon atoms.

7. The method of cleaning hair which comprises: contacting the hair with the cleaning wipe of claim 1.

8. The method of cleaning skin which comprises: contacting the skin with the cleaning wipe of claim 1.

9. The method of cleaning domestic pets and working animals which comprises: contacting the domestic pets and working animals with the cleaning wipe of claim 1.

10. The cleaning wipes of claim 1, wherein, a ratio of monoester to diester is from 3:1 to 10:1 and the monoesters and diesters comprise from 50% to 90% by weight of the alkylether citrate partial ester mixture.

11. The cleaning wipes of claim 10, wherein, a sum of the monoester and diester comprises from 60% to 80% by weight of the alkylether citrate partial ester mixture.

12. The cleaning wipes of claim 10, wherein, the ratio of monoester to diester is from 5:1 to 8:1.

13. The cleaning wipes of claim 1, wherein, the alkylether citrate comprises 0% to 3% by weight alkyl group residues containing less than 12 carbon atoms and 0% to 1% by weight alkyl group residues containing more than 18 carbon atoms based on the weight of alkyl alcohol from which the alkyl residues were derived.

14. The cleaning wipes of claim 13, wherein, the alkylether groups have a number of ethoxy groups of from 5 to 9.

15. The cleaning wipes of claim 1, wherein, the alkylether citrate comprises 45% to 75% by weight alkyl group residues containing 12 carbon atoms, 15% to 35% by weight alkyl group residues containing 14 carbon atoms, 0% to 15% by weight alkyl group residues containing 16 carbon atoms and 0% to 20% by weight alkyl group residues containing 18 carbon atoms based on the weight of alkyl alcohol from which the alkyl residues were derived.

16. The cleaning wipes of claim 10, wherein, the alkylether citrate comprises 0% to 3% by weight alkyl group residues containing less than 12 carbon atoms and 0% to 1% by weight alkyl group residues containing more than 18 carbon atoms based on the weight of alkyl alcohol from which the alkyl residues were desired.

17. The cleaning wipes of claim 16, wherein, the alkylether groups have a number of ethoxy groups of from 5 to 9.

18. The cleaning wipes of claim 14, wherein, the alkylether citrate comprises 45% to 75% by weight alkyl group residues containing 12 carbon atoms, 15% to 35% by weight alkyl group residues containing 14 carbon atoms, 0% to 15% by weight alkyl group residues containing 16 carbon atoms and 0% to 20% by weight alkyl group residues containing 18 carbon atoms based on the weight of alkyl alcohol from which the alkyl residues were derived.

19. The cleaning wipes of claim 1, wherein, the alkylether citrate partial ester mixture contains less than 10% by weight of free citric acid.

20. The cleaning wipes of claim 1 further comprising: an additional surfactant, a moisturizing agent and a defatting agent.
